(19) United States
(12) Patent Application Publication
(10) Pub. No.: US 2007/0171195 A1
(43) Pub. Date: Jul. 26, 2007

(54) Sliding/swing-type portable terminal capable of positioning liquid crystal display at center portion thereof and method of using the same

(75) Inventors: Jong-Yang Kim, Seoul (KR); Soo-Ik Jung, Seoul (KR); Byung-Chan Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/646,396

(22) Filed: Dec. 28, 2006

(30) Foreign Application Priority Data
Jan. 26, 2006 (KR) 2006-8477
Oct. 30, 2006 (KR) 2006-105686

(51) Int. Cl. G09G 5/00

(52) U.S. Cl. 345/156

(57) ABSTRACT

A sliding/swing-type portable terminal with a liquid crystal display unit is provided. The sliding/swing-type portable terminal can guide the swing movement of the liquid crystal display unit to the center portion of the terminal when the terminal swings. The sliding/swing-type portable terminal includes a body housing, a sliding housing provided with a liquid crystal display unit, and sliding and swinging on the body housing to be opened and closed, and a sliding/swing hinge device for allowing the sliding housing to slide and swing on the body housing. The sliding/swing hinge device includes a guide bar provided on the sliding housing and a guide member provided to the body housing for guiding the sliding and swinging movement of the guide bar. When the sliding housing swings, the guide member guides the movement of the guide bar at a termination position of the sliding movement of the sliding housing so that the liquid crystal display unit of the sliding housing is positioned at a center portion of the body housing.

### PRIORITY

This application claims the benefit under 35 U.S.C. § 119(a) of Korean Patent Applications filed in the Korean Intellectual Property Office on Jan. 26, 2006 and Oct. 30, 2006, and assigned Serial Nos. 2006-8477 and 2006-105686, respectively, the entire disclosures of which are incorporated herein by reference.

### BACKGROUND OF THE INVENTION

1. Field of the Invention

The present invention relates to a sliding/swing-type portable terminal comprising a liquid crystal display. More particularly, the present invention relates to a portable terminal which can guide and move the liquid crystal display toward a center portion thereof when the terminal rotates.

2. Description of the Related Art

Portable communication terminals generally refer to electronic devices which may be carried with a user while the user communicates wirelessly with another user. Such portable communication devices include Hand-Held Phones (HHP), CT-2, cellular phones, digital phones, Personal Communication System (PCS) phones, and Personal Digital Assistants (PDAs). Conventional portable terminals may be classified into various types according to their appearance, such as bar-type portable terminals, flip-type portable terminals, and folder-type portable terminals. The bar-type portable terminal has a single housing shaped like a bar. The flip-type portable terminal has a flip panel which is pivotally mounted to a bar-shaped housing by a hinge unit. The folder-type portable terminal has a folder coupled to a single bar-shaped housing by a hinge unit that facilitates the rotation of the folder so that it can be folded or unfolded from the housing. Further, portable terminals may be classified as neck wearable-type terminals and wrist wearable-type terminals, according to the position or way in which a user wears the terminal. A user wears the neck wearable-type terminal around the neck using a lanyard or necklace. Alternatively, the user wears the wrist wearable-type terminal around the wrist. Additionally, portable terminals may be classified as rotation-type terminals, sliding-type terminals, and sliding/swing-type terminals according to the manner of opening and closing the terminal. In the rotation-type portable terminal, two housings are coupled to each other in a manner such that one housing rotates to be opened or closed relative to the other while facing each other. In the sliding-type portable terminal, two housings are coupled to each other in a manner such that one housing slides to be opened or closed relative to the other. In the sliding/swing-type portable terminal, two housing are coupled to each other in a manner that one housing swings on the other after sliding on the other housing.

The conventional portable terminal essentially includes an antenna, data input/output units, data transmitter and data receiver. A keypad is used as the data input unit, on which a user can press keys with his/her fingers to input data. A touch pad or a touch screen may also be used as the data input unit.

A liquid crystal display unit is also generally used as the data output unit to display data.

Further, the conventional portable terminal may be provided with a camera lens. Therefore, it is possible to perform image communication with a desired partner or to photograph a desired subject.

As illustrated in FIG. 1, the sliding/swing-type portable terminal 10 includes a body housing 20, a sliding housing 30 sliding and swinging on the body housing 20 to be opened and closed while facing the body housing 20. The sliding/swing-type portable terminal 10 also includes a sliding/swing hinge device 40 to allow the sliding housing 30 to slide and swing on the body housing 20.

FIGS. 1 and 2 illustrate the body housing 20 with a keypad 21 including a plurality of keys arranged thereon. The sliding housing 30 also includes a liquid crystal display unit 31.

However, in the conventional sliding/swing-type portable terminal, the liquid crystal display unit of the sliding housing is located in a position that does not have a common center with the center portion of the body housing when the sliding housing slides and swings. Accordingly, the liquid crystal display unit must be inconveniently shifted to the center portion of the body housing after the sliding housing swings.

In order to overcome the above-mentioned defect, the hinge device must have a separate guide unit and stopper. In this case, the portable terminal is required to have sufficient space to mount the guide unit and stopper. This produces an increase in the volume of the portable terminal and reduces the ability of the portable terminal to be miniaturized. In addition, there is an increase in the number of parts which thereby increases manufacturing costs and assembly time.

Accordingly, there is a need for an improved system and method for improving the display capabilities of a liquid crystal display unit and for increasing convenience to a user.

### SUMMARY OF THE INVENTION

An object of exemplary embodiments of the present invention is to address at least the above problems and/or disadvantages and to provide at least the advantages described below. Accordingly, an object of exemplary embodiments of the present invention is to provide a sliding/swing-type portable terminal having a liquid crystal display unit, which has a guide device to guide the liquid crystal display unit to a center portion of the terminal when the terminal swings, thereby improving the displaying function of the liquid crystal display unit and user's convenience.

In an exemplary embodiment of the present invention, a sliding/swing-type portable terminal with a liquid crystal display unit is provided. A hinge device is eccentrically mounted on the terminal to facilitate the shift of the liquid crystal display unit along the hinge axis of the eccentric hinge device to the center portion of the terminal.

According to another exemplary embodiment of the present invention, a swing-type portable terminal is provided. In this swing-type portable terminal, a swing housing can swing clockwise and counterclockwise along a desired trajectory and a central axis of the swing housing can be shifted, thereby positioning the liquid crystal display unit of the swing housing at the center portion of the body housing.

According to another exemplary embodiment of the present invention, a sliding/swing-type portable terminal is provided. The sliding/swing-type portable terminal comprises a body housing, a sliding housing and a sliding/swing hinge device. The sliding housing is provided with a liquid crystal display unit and sliding and swinging on the body housing to be opened and closed. The sliding/swing hinge device allows the sliding housing to slide and swing on the body housing and includes a guide bar provided on the sliding housing and a guide member provided to the body housing for guiding the sliding and swinging movement of the guide bar. When the sliding housing swings, the guide member guides the movement of the guide bar at a termination position of the sliding movement of the sliding housing so that the liquid crystal display unit of the sliding housing is positioned at a center portion of the body housing.

According to another exemplary embodiment of the present invention, a swing-type portable terminal is provided. The swing-type portable terminal comprises a body housing, a swing housing, a guide pin and at least one guide member. A swing housing is provided with a liquid crystal display unit and rotates around a hinge axis extending perpendicularly to an upper surface of the body housing while facing the body housing. A guide pin is provided to the swing housing. At least one guide member is provided to the body housing to guide the movement of the guide pin along a predetermined trajectory to move a central axis of the swing housing when the swing housing swings clockwise or counterclockwise and to position the liquid crystal display unit of the swing housing at the center portion of the body housing.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features, and advantages of certain exemplary embodiments of the present invention will be more apparent from the following description taken in conjunction with the accompanying drawings, in which:

FIG. 1 is an exploded perspective view illustrating a configuration of a sliding hinge device of a conventional sliding/swing-type portable terminal;

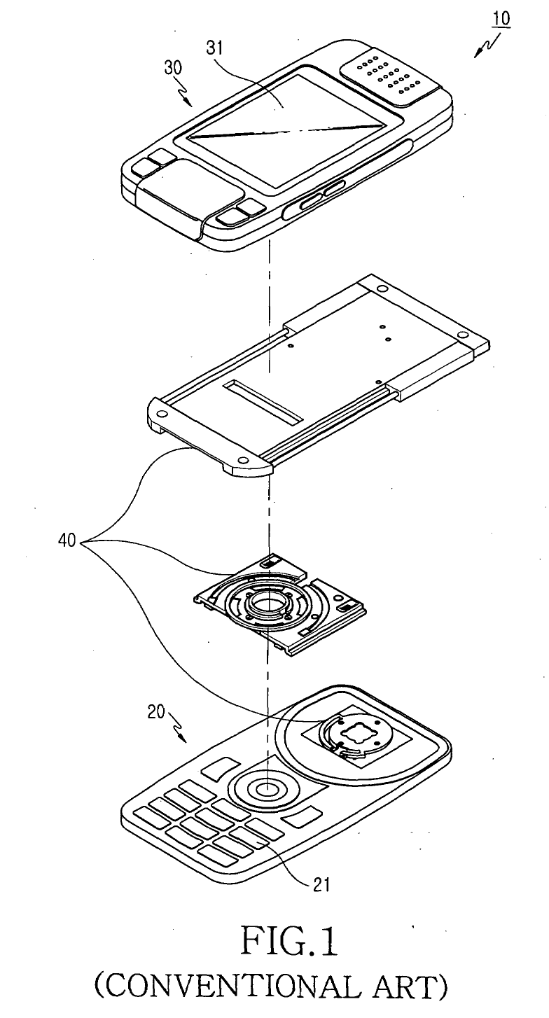

FIG. 2 is a front view illustrating the conventional sliding/swing-type portable terminal, in which a sliding hinge device is assembled with the sliding/swing-type portable terminal;

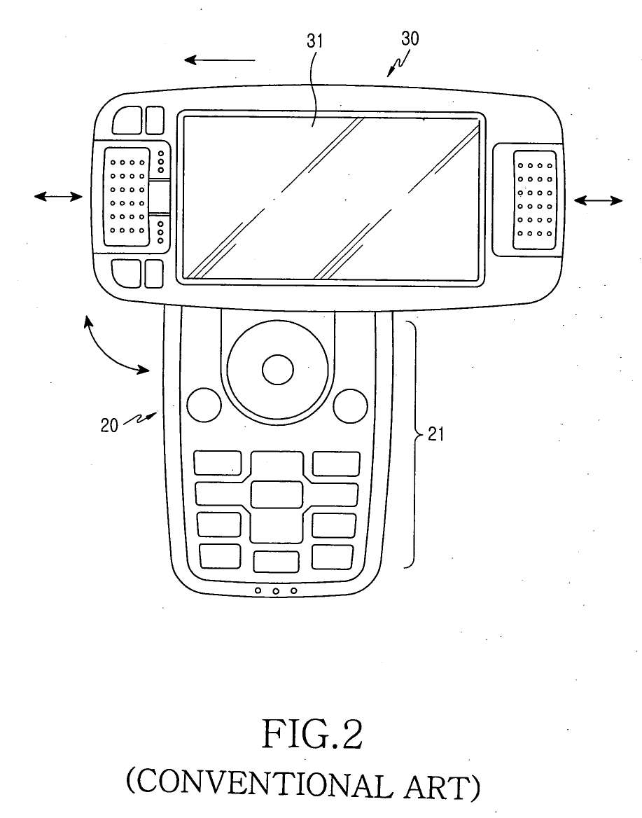

FIG. 3 is an exploded perspective view showing a configuration of a sliding/swing-type portable terminal capable of positioning a liquid crystal display at the center portion thereof according to the first exemplary embodiment of the present invention;

FIG. 4 is a perspective view illustrating the sliding/swing-type portable terminal capable of positioning the liquid crystal display at the center portion thereof according to the first exemplary embodiment of the present invention, before the assembly of the sliding/swing-type portable terminal;

FIG. 5 is a perspective view illustrating the sliding/swing-type portable terminal capable of positioning the liquid crystal display at the center portion thereof according to the first exemplary embodiment of the present invention, before the sliding movement of the portable terminal;

FIG. 6 is a front view illustrating the sliding/swing-type portable terminal capable of positioning the liquid crystal display at the center portion thereof according to the first exemplary embodiment of the present invention, after the sliding movement of the portable terminal;

FIG. 7 is a front view illustrating the sliding/swing-type portable terminal capable of positioning the liquid crystal display at the center portion thereof according to the first exemplary embodiment of the present invention, in which the portable terminal rotates;

FIG. 8 is a front view illustrating the sliding/swing-type portable terminal capable of positioning the liquid crystal display at the center portion thereof according to the first exemplary embodiment of the present invention, in which the portable terminal rotates;

FIG. 9 is an exploded perspective view illustrating the configuration of a sliding/swing-type portable terminal capable of positioning a liquid crystal display at the center portion thereof according to the second exemplary embodiment of the present invention;

FIG. 10 is a perspective view illustrating the sliding/swing-type portable terminal capable of positioning the liquid crystal display at the center portion thereof according to the second exemplary embodiment of the present invention;

FIG. 11 is a perspective view illustrating the sliding/swing-type portable terminal capable of positioning the liquid crystal display at the center portion thereof according to the second exemplary embodiment of the present invention, in which a rotation housing rotates at an angle of 180 degrees;

FIG. 12 is a front view illustrating the sliding/swing-type portable terminal capable of positioning the liquid crystal display at the center portion thereof according to the second exemplary embodiment of the present invention, in which the rotation housing rotates at an angle of 180 degrees;

FIG. 13 is a front view illustrating the sliding/swing-type portable terminal capable of positioning the liquid crystal display at the center portion thereof according to the second exemplary embodiment of the present invention, in which the rotation housing rotates counterclockwise after rotation at an angle of 180 degrees;

FIG. 14 is a front view illustrating the sliding/swing-type portable terminal capable of positioning the liquid crystal display at the center portion thereof according to the second exemplary embodiment of the present invention, in which the rotation housing rotates clockwise after rotation at an angle of 180 degrees;

FIG. 15 is a perspective view illustrating the sliding/swing-type portable terminal capable of positioning the liquid crystal display at the center portion thereof according to the second exemplary embodiment of the present invention, before the rotation housing rotates; and

FIG. 16 is a front view illustrating the sliding/swing-type portable terminal capable of positioning the liquid crystal display at the center portion thereof according to the second exemplary embodiment of the present invention, in which the rotation housing rotates clockwise.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

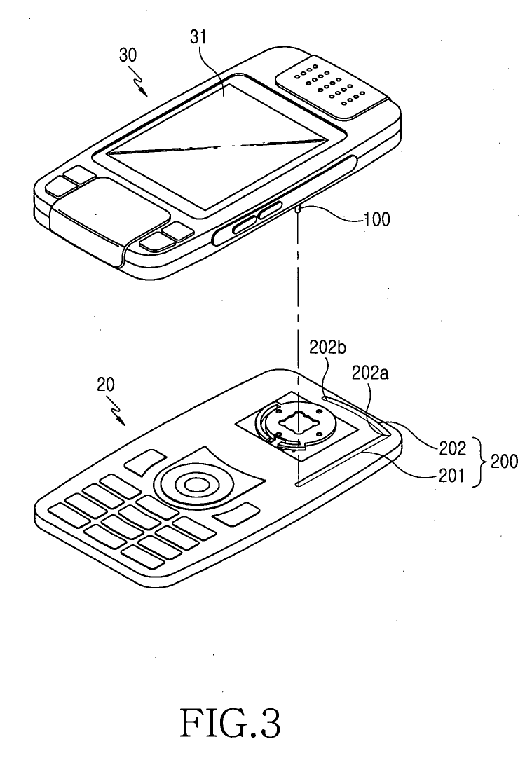

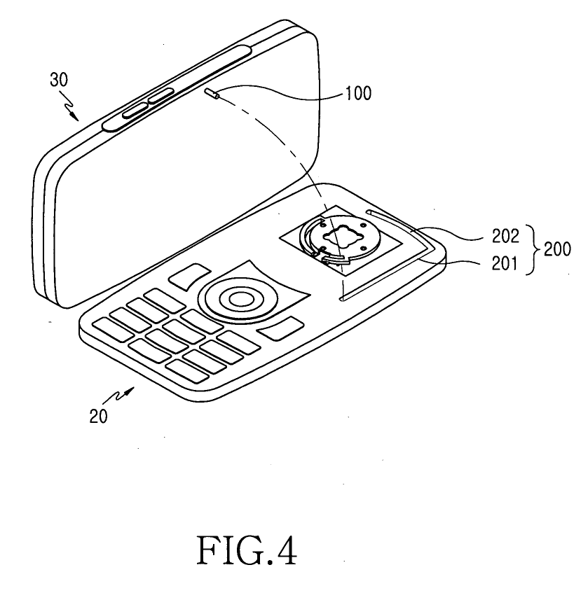

As illustrated in FIGS. 3 and 4, a sliding/swing-type portable terminal 10, according to a first exemplary embodiment of the present invention, includes a body housing 20, a sliding housing 30 provided with a liquid crystal display unit 31 and sliding and swinging on the body housing 20 to be opened and closed, and a sliding/swing hinge device 40 to facilitate the sliding housing's 30 ability to slide. The sliding-type portable terminal capable of positioning the liquid crystal display unit 31 at the center portion thereof is provided with a guide bar 100 and a guide member 200. The guide bar 100 is provided on a rear surface of the sliding housing 30 and inserted into the guide member 200 so as to slide and swing. The guide member 200 is formed on the upper surface of the body housing 20 in order to guide the guide bar 100 so that the guide bar 100 slides and rotates. Further, the guide member 200 guides the movement of the guide bar 100 when the sliding housing 30 swings after the sliding movement of the sliding housing 30. In addition, the guide member 200 guides the sliding housing 30 so that the liquid crystal display unit 31 of the sliding housing is positioned at the center portion of the body housing 20.

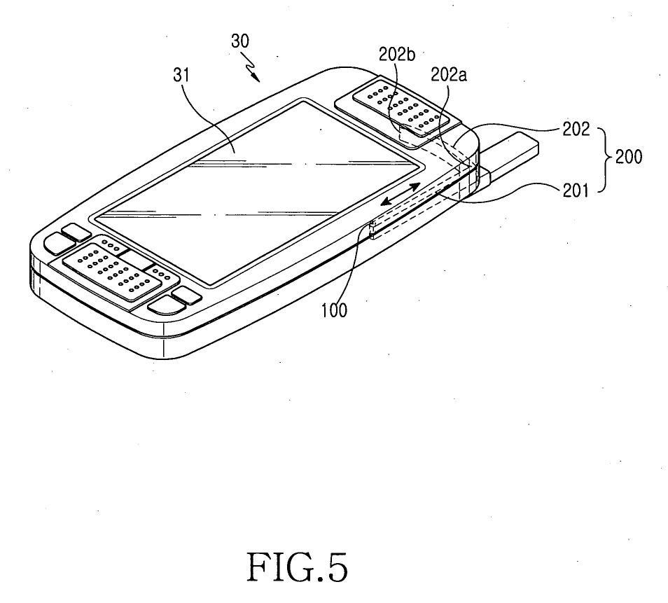

As illustrated in FIG. 5, the guide bar 100 protrudes by a desired length so that the guide bar 100 is inserted into the guide member 200.

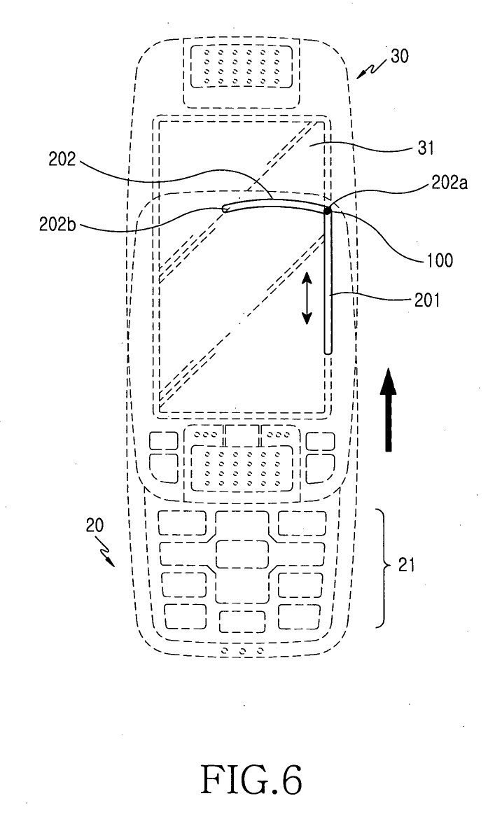

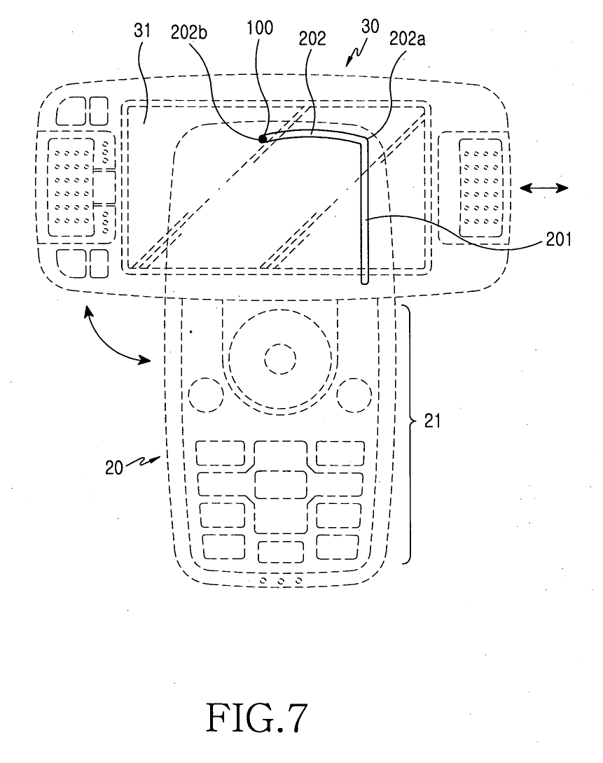

As illustrated in FIGS. 6 and 7, the guide member 200 includes the first and second guide grooves 201 and 202. The first guide groove 201 is formed along a lengthwise direction of the body housing 20 to guide the movement of the guide bar 100 toward a position at which the sliding movement of the sliding housing 30 terminates. The second guide groove 202 is formed at an end of the first guide groove 201 to be perpendicular to the first guide groove 201 so that the guide bar 100 moves along the second guide groove 202 when the sliding housing 30 rotates after the sliding movement of the sliding housing 30 terminates.

As illustrated in FIG. 7, the second guide groove 202 has the first stopper 202a provided at an end to stop the movement of the guide bar 100 at the termination position of the sliding movement, and the second stopper 202b provided at the other end to restrain the movement of the guide bar 100 at the termination position of the rotation.

As illustrated in FIGS. 4 and 6, the guide bar 100 has a cylindrical shape which facilitates easy movement along the first and second guide grooves 201 and 202.

As illustrated in FIGS. 6 and 7, the first and second guide grooves 201 and 202 have a rotated letter “L” shape respectively. Both ends of the first and second guide grooves 201 and 202 are formed of semi-circular shapes in order to receive the guide bar 100. The second guide groove 202 is formed to have a desired curvature to allow a smooth movement of the guide bar 100 when the sliding housing 30 rotates.

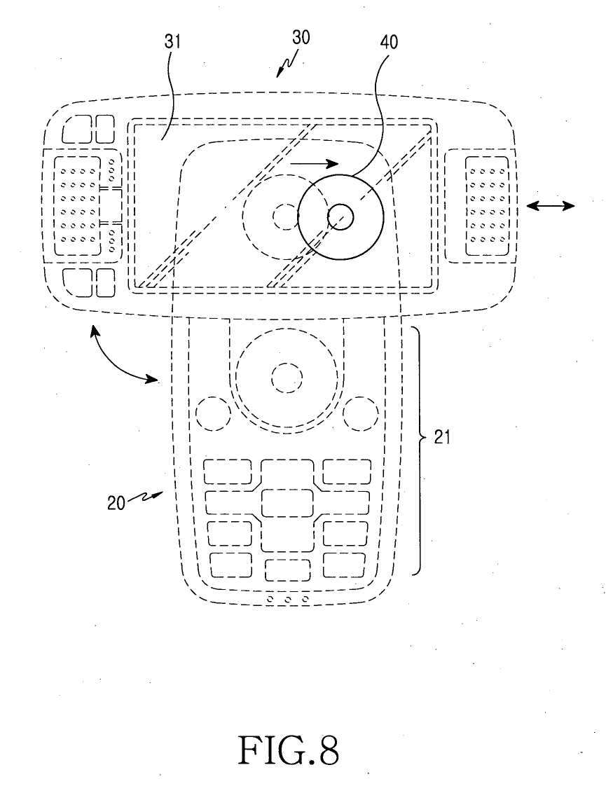

FIG. 8 shows a sliding/swing-type portable terminal 10 according to another exemplary embodiment of the present invention, which can position a liquid crystal display unit 31 at the center portion thereof. Referring to FIG. 8, a sliding/swing hinge device 40 is eccentrically installed on a side of the body housing 20. When the sliding housing 30 rotates, the liquid crystal display unit 31 of the sliding housing 30 can be positioned at the center portion of the body housing 20 by means of the eccentric hinge device.

The operation of the sliding/swing-type portable terminal according to the first exemplary embodiment of the present invention, which can position the liquid crystal display unit at the center portion thereof, will be described in detail with reference to FIGS. 5 to 7.

As illustrated in FIGS. 3 and 4, the sliding/swing-type portable terminal includes the guide bar 100 and the guide member 200 in order to position the liquid crystal display unit 31 at the center portion of the body housing 20.

As illustrated in FIGS. 4 and 5, the guide member 200 includes the first and second guide grooves 201 and 202. When the sliding housing 30 is assembled with the body housing 20 while they face each other, the guide bar 100 is inserted into the first guide groove 201.

As illustrated in FIG. 4, the guide bar 100 protrudes by a desired length, and the first and second grooves 201 and 202 are formed to be concave with a desired depth.

As illustrated in FIG. 6, when the sliding housing 30 moves away from the body housing, the guide bar 100 moves along with the sliding housing 30. According to an exemplary implementation, the guide bar 100 moves along the first guide groove 201.

When the sliding housing 30 reaches the position of terminating the sliding movement thereof, the guide bar 100 stops the movement thereof once it makes contact with the first stopper 202a formed at one end of the second guide groove 202.

According to an exemplary implementation, as illustrated in FIG. 7, the guide bar 100 moves along with the sliding housing 30 when the sliding housing 30 rotates. The guide bar 100 moves along the second guide groove 202.

Since the second guide groove 202 is formed to have a desired curvature, the guide bar 100 can easily move along with the sliding housing 30.

At this time, the guide bar 100 makes contact with the second stopper 202b formed at the other end of the second guide groove 202 and stops its movement.

According to an exemplary implementation, the liquid crystal display unit 31 of the sliding housing 30 is positioned at the center portion of the body housing 20.

The user can play a game or watch TV through the liquid crystal display unit 31 positioned at the center portion of the body housing 20.

The sliding/swing-type portable terminal 10, according to another exemplary embodiment of the present invention, which can position the liquid crystal display unit 31 at the center portion thereof, will be described.

FIG. 8 illustrates the sliding/swing-type portable terminal capable of positioning the liquid crystal display unit at the center portion thereof. In the sliding/swing-type portable terminal, the sliding/swing hinge device 40 is eccentrically mounted on a side of the body housing 20 to allow the sliding housing 30 to rotate about a hinge axis of the eccentric hinge device. As a result, the liquid crystal display unit 31 of the sliding housing 30 is positioned at the center portion of the body housing 20.

Since the sliding/swing hinge device 40 is eccentrically mounted on a side of the body housing 20 without the use of a separate device, it is possible to easily position the liquid crystal display unit 31 of the sliding housing at the center portion of the body housing 20. Further, it is possible to decrease the number of the parts and reduce manufacturing costs. The portable terminal may also be miniaturized because a separate installing space is unnecessary.

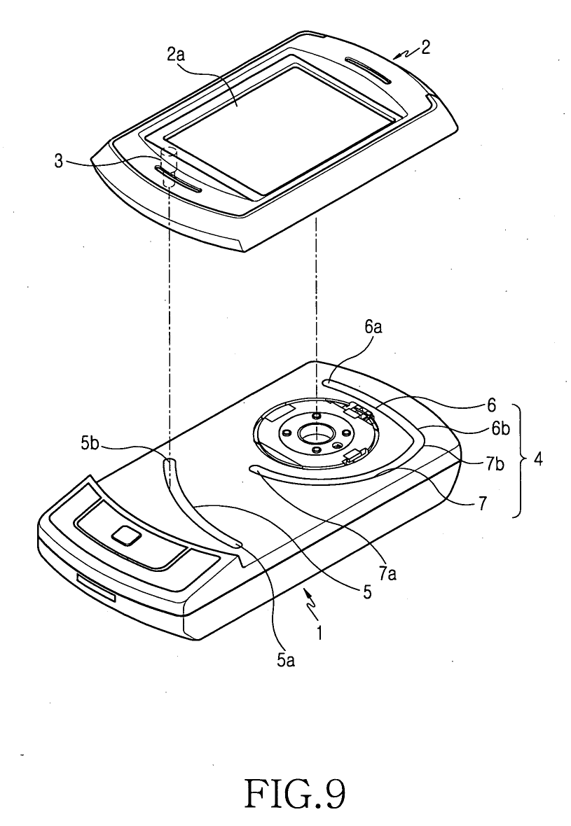

The operation of the swing-type portable terminal, according to the second exemplary embodiment of the present invention, which has the configuration as described above and can position the liquid crystal display unit at the center portion thereof, will be described in detail with reference to FIGS. 9 to 16.

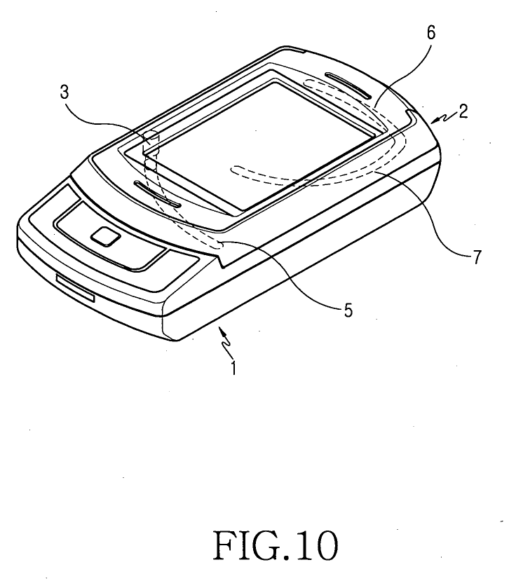

As illustrated in FIGS. 9 and 10, the swing-type portable terminal capable of positioning a liquid crystal display unit 2a at the center portion thereof includes a body housing 1, a swing housing 2, a guide pin 3, and a guide member 4.

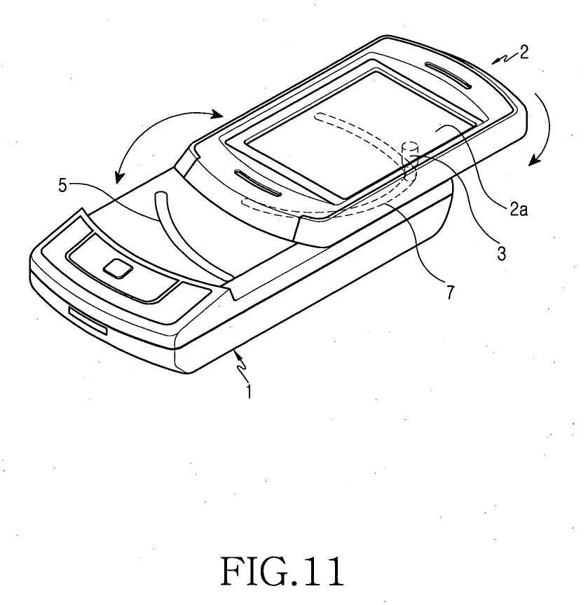

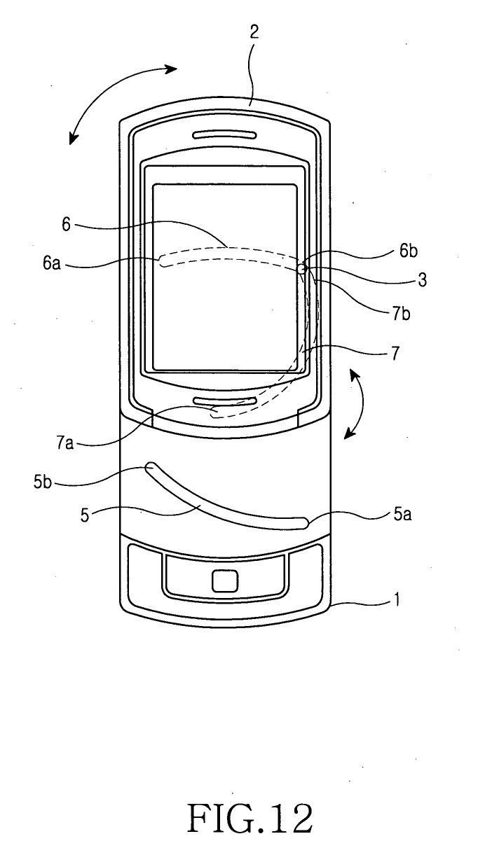

As illustrated in FIGS. 11 and 12, the swing housing 2 is rotated by an angle of 180 degrees about a hinge axis A1 extending perpendicularly to an upper surface of the body housing 1 while facing the body housing 1.

At this time, the guide pin 3 provided to the swing housing 2 is movably received in the guide member 4.

According to an exemplary implementation, the guide pin 3 includes a pogo pin. The guide pin 3 is out of the guide member 4 when the swing housing 2 does not swing, while rotating along with the swing housing 2 and being inserted into the guide member 4 when the swing housing 2 rotates by an angle of 180 degrees.

The guide member 4 includes first, second, and third guide grooves 5, 6 and 7.

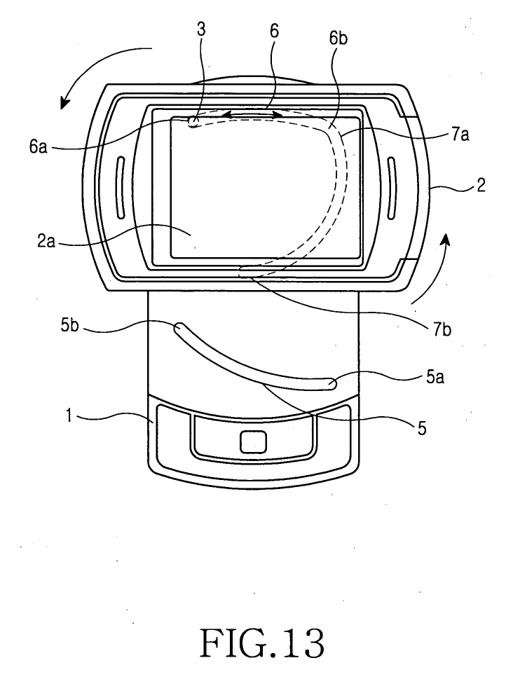

As illustrated in FIG. 13, the pogo pin 3 is inserted into the second and third guide grooves 6 and 7. When the swing housing 2 rotates counterclockwise, the pogo pin 3 rotates along with the swing housing 2 and moves along a predetermined trajectory to shift the central axis of the swing housing 2. Accordingly, the liquid crystal display unit 2a provided on the swing housing 2 is positioned at the center portion of the body housing 1.

The pogo pin 3 of the swing housing 2 departs from the second stopper 6b, and simultaneously moves along a predetermined trajectory in the second guide groove 6 with a desired curvature. The pogo pin 3 makes contact with the first stopper 6a formed at the other end of the second guide groove 6 and stops its movement. While the swing housing 2 swings, the central axis of the swing housing 2 moves so that the liquid crystal display unit 2a of the swing housing 2 is positioned at the center portion of the body housing 1.

According to an exemplary implementation, the user can play a game or watch TV through the liquid crystal display unit positioned at the center portion of the body housing 1.

According to an exemplary implementation, when the swing housing 2 of FIG. 12 is swung clockwise again, the swing housing 2 returns to an initial position. The pogo pin 3 departs from the first stopper 6a and makes contact with the second stopper 6b to stop its movement at a swing stopping position.

The swing housing 2 rotates at an angle of 180 degrees and returns to the initial position.

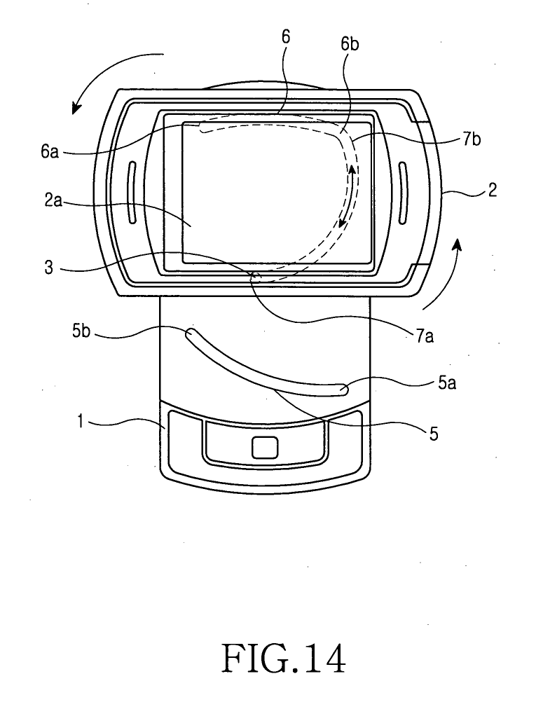

In this state, as illustrated in FIG. 14, when the swing housing 2 rotates clockwise, the pogo pin 3 moves along with the swing housing 2 while moving along a predetermined trajectory in the third guide groove 7 to shift the central axis of the swing housing 2. Accordingly, the liquid crystal display unit 2a provided on the swing housing 2 can be positioned at the center portion of the body housing 1.

The pogo pin 3 of the swing housing 2 departs from the second stopper 7b formed in the third guide groove 7 and simultaneously moves along a predetermined trajectory in the third guide groove 7 with the desired curvature. The pogo pin 3 makes contact with the first stopper 7b formed at the other end of the third guide groove 3 and stops its movement. When the swing housing 2 rotates, the central axis of the swing housing 2 is simultaneously shifted so that the liquid crystal display unit 2a of the swing housing 2 is positioned at the center portion of the body housing 1.

According to an exemplary implementation, the user can play a game or watch TV through the liquid crystal display unit 2a positioned at the center portion of the body housing.

As illustrated in FIG. 12, when the swing housing 2 rotates clockwise again and returns to the initial position, the pogo pin 3 departs from the first stopper 7a and makes contact with the second stopper 7b to stop its movement at the swing termination position.

The swing housing 2 returns to the initial position by swinging by an angle of 180 degrees.

In this state, as illustrated FIG. 10, the swing housing 2 rotates by an angle of 180 degrees counterclockwise and faces the body housing 1.

According to an exemplary implementation, the pogo pin 3 moves along with the swing housing 2 and is inserted into the first guide groove 5.

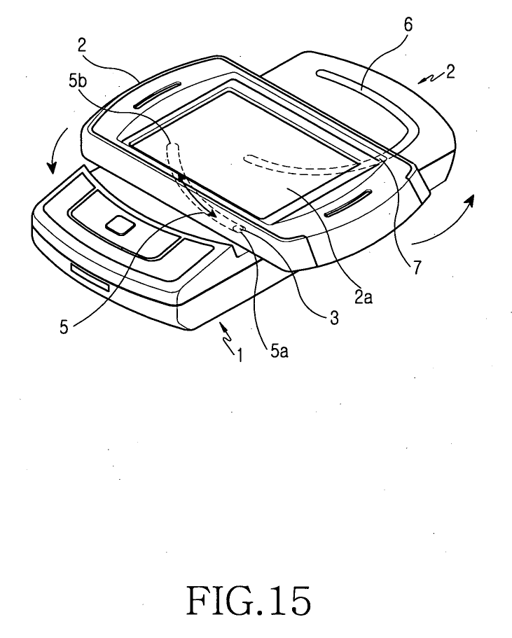

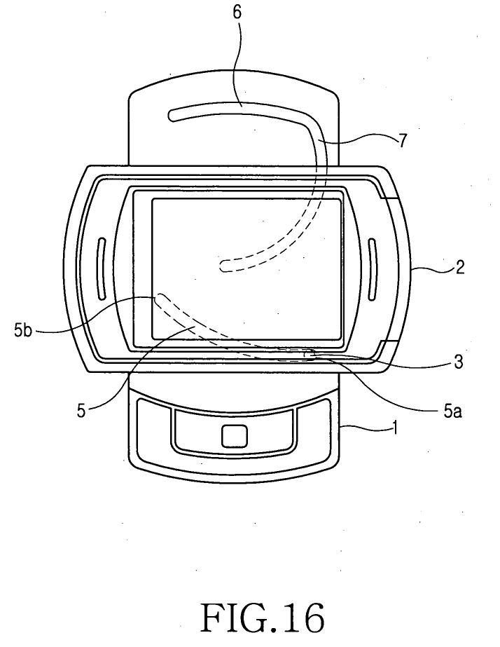

As illustrated in FIGS. 15 and 16, when the swing housing 2 rotates counterclockwise, the pogo pin 3 moves along with the swing housing 2 along a predetermined trajectory in the first guide groove 5, and thereby the central axis of the swing housing 2 is shifted. Accordingly, the liquid crystal display device 2a provided on the swing housing 2 is positioned at the center portion of the body housing 1.

According to an exemplary implementation, the pogo pin 3 of the swing housing 2 departs from the second stopper 5b formed in the first guide groove 5 and simultaneously moves along a predetermined trajectory in the guide groove 5 having the desired curvature. Then, the pogo pin 3 makes contact with the first stopper 5a formed at the other end of the first guide groove 5 to stop its movement. When the swing housing moves, the central axis of the swing hinge 2 is shifted so that the liquid crystal display unit 2a of the swing housing 2 rotates about the center portion of the body housing 1.

According to an exemplary implementation, the user can play a game or watch TV through the liquid crystal display unit 2a which is positioned at the center portion of the body housing 1.

According to an exemplary implementation, when the swing housing 2 rotates clockwise again and returns to the initial position, the pogo pin 3 departs from the first stopper 5a and makes contact with the second stopper 5b to stop its movement at the position of terminating its movement.

As illustrated in FIG. 10, the swing housing 2 returns to the initial position with facing the body housing 1.

The present invention is applicable to all types of portable terminals.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A sliding/swing-type portable terminal comprising:
a body housing;
a sliding housing provided with a liquid crystal display unit, and sliding and swinging on the body housing to be opened and closed; and
a sliding/swing hinge device for allowing the sliding housing to slide and swing on the body housing, the sliding/swing hinge device comprising a guide bar provided on the sliding housing and a guide member provided to the body housing for guiding the sliding and swinging movement of the guide bar;
wherein, the guide member guides the movement of the guide bar at a termination position of the sliding movement of the sliding housing so that the liquid crystal display unit of the sliding housing is positioned at a center portion of the body housing when the sliding housing swings.

2. The sliding/swing-type portable terminal as claimed in claim 1, wherein the guide bar protrudes with a desired length.

3. The sliding/swing-type portable terminal as claimed in claim 1, wherein the guide member comprises a first guide groove for guiding the movement of the guide bar to the termination position of the sliding housing, and a second guide groove for guiding the movement of the guide bar when the sliding housing swings at the termination position of the sliding movement of the sliding housing.

4. The sliding/swing-type portable terminal as claimed in claim 3, wherein a first stopper is provided to one end of the second guide groove to stop the movement of the guide bar at a position where the sliding movement of the sliding housing terminates, and a second stopper is provided to the other end of the second guide groove to stop the movement of the guide bar at a position where the swing movement of the sliding housing terminates.

5. The sliding/swing-type portable terminal as claimed in claim 1, wherein the guide bar comprises a cylindrical shape.

6. The sliding/swing-type portable terminal as claimed in claim 3, wherein the first and second guide grooves respectively comprise a rotated letter “L” shape.

7. The sliding/swing-type portable terminal as claimed in claim 3, wherein the first and second guide grooves respectively comprise an end semi-circularly formed.

8. The sliding/swing-type portable terminal as claimed in claim 3, wherein the second guide groove comprises a desired curvature.

9. A sliding/swing-type portable terminal comprising:
a body housing;
a sliding housing provided with a liquid crystal display unit, and sliding and swinging on the body housing to be opened and closed; and
a sliding/swing hinge device for allowing the sliding housing to slide and swing, wherein the sliding/swing hinge device is eccentrically mounted on the body housing for positioning the liquid crystal display unit of the sliding housing at the center portion of the body housing when the sliding housing swings.

10. A swing-type portable terminal comprising:
a body housing;
a swing housing provided for rotating along with a liquid crystal display unit; and
a guide device for guiding the swing movement of the swing housing and positioning the liquid crystal display unit of the swing housing at the center portion of the body housing when the swing housing swings.

11. A swing-type portable terminal comprising:
a body housing;
a swing housing for rotating around a hinge axis extending perpendicularly to an upper surface of the body housing while facing the body housing, wherein the swing housing comprises a liquid crystal display unit;
a guide pin provided to the swing housing; and
at least one guide member provided to the body housing for guiding the movement of the guide pin along a predetermined trajectory to move a central axis of the swing housing when the swing housing swings in at least one of a clockwise and counterclockwise direction and for positioning the liquid crystal display unit of the swing housing at the center portion of the body housing.

12. The swing-type portable terminal as claimed in claim 11, wherein the guide member comprises first, second and third guide grooves, wherein the first guide grooves allow the swing housing to swing clockwise and counterclockwise on the body housing and guide the movement of the guide pin along the desired trajectory to shift the central axis of the swing housing, the second guide grooves allow the swing housing to swing counterclockwise on the body housing and guide the movement of the guide pin along the desired trajectory to shift the central axis of the swing housing, and the third guide groove allows the swing housing to swing clockwise on the body housing and guide the movement of the guide pin along the desired trajectory to shift the central axis of the swing housing.

13. The swing-type portable terminal as claimed in claim 12, wherein the first, second and third guide grooves comprise a first stopper at one end thereof to stop the movement of the guide pin at a position where the guide pin terminates its movement after the guide pin moves along the desired trajectory, and a second stopper at the other end thereof to stop the movement of the guide pin and the swinging movement of the swing housing at a position where the guide pin terminates its movement after the guide pin moves along the desired trajectory.

14. The swing-type portable terminal as claimed in claim 11, wherein the guide pin comprises a pogo pin.

15. The sliding/swing-type portable terminal as claimed in claim 3, wherein the first guide groove is formed in a longitudinal direction of the body housing and the second guide groove is formed at an end of the first guide groove.

16. A method of using a sliding/swing-type portable terminal comprising:
sliding and swinging a sliding housing on a body housing;
guiding the sliding and swinging movement of a guide bar; and
positioning a liquid crystal display unit of the sliding housing at a center portion of the body housing when the sliding housing swings.

17. The method of claim 16, wherein the guide bar protrudes with a desired length.

18. The method of claim 16, further comprising guiding the movement of the guide bar to the termination position of the sliding housing, and guiding the movement of the guide bar when the sliding housing swings at the termination position of the sliding movement of the sliding housing.
